(19) United States
(12) Patent Application Publication
(10) Pub. No.: US 2008/0218464 A1
(43) Pub. Date: Sep. 11, 2008

(54) DEVICE CONTROL APPARATUS AND IMAGE DISPLAY APPARATUS

(75) Inventor: Fumio KOYAMA, Shiojiri-shi (JP)

Correspondence Address: OLIFF & BERRIDGE, PLC, P.O. BOX 320850, ALEXANDRIA, VA, 22320-4850, US

(73) Assignee: SEIKO EPSON CORPORATION, Tokyo (JP)

(21) Appl. No.: 12/037,292

(22) Filed: Feb. 26, 2008

(30) Foreign Application Priority Data
Mar. 6, 2007 (JP) 2007-055250

(51) Int. Cl. G09G 3/36

(52) U.S. Cl. 345/89

(57) ABSTRACT

A device control apparatus that controls an image display device including a plurality of main scan lines is disclosed. The apparatus includes: a cumulative correction value calculation section that calculates, in response to an input image signal, a cumulative correction value in accordance with a cumulative value of each gray-scale value of input image data provided for each of the main scan lines; a cumulative correction value storage section that stores the calculated cumulative correction value for each of the main scan lines; and a device control section that controls, based on N (where N is an integer of 2 or larger) of the main scan lines read from the cumulative correction value storage section, the image display device to suppress a gray-scale deviation resulted from display of the N of the main scan lines.

The entire disclosure of Japanese Patent Application No. 2007-055250, filed Mar. 6, 2007 is expressly incorporated by reference herein.

### BACKGROUND

1. Technical Field

The present invention relates to a technology for adjusting input/output characteristics of an image display apparatus.

2. Related Art

The image quality degradation, i.e., crosstalk, has recently become apparent also in liquid crystal panels of an active matrix type. Such crosstalk is caused by the higher driving speed for the liquid crystal panels, the larger number of pixels, the higher pixel density, and others. For suppressing the crosstalk having become apparent as such, various many technologies have been proposed. For example, patent Documents 1 (JP-A-2005-202159) and 2 (JP-A-2006-91800) describe the technology of suppressing any deviation of a gray-scale value of a scan line in accordance with an integral value of a gray-scale value of a scan line driven immediately therebefore. To be specific, patent Documents 1 and 2 describe the technology of adjusting the precharge voltage of a data line and image signals in accordance with the integral value of a gray-scale value of a scan line driven immediately before a scan line of a driving target. On the other hand, patent Documents 3 (JP-A-2006-163074) and 4 (JP-A-2006-162872) describe the technology of suppressing any deviation, i.e., crosstalk in a broad sense, of a gray-scale value occurred in accordance with the integral value of a gray-scale value of a driving target, i.e., scan line. Other examples include patent Documents 5 (JP-A-2005-227474) and 6 (JP-A-2005-258419).

The problem is that if the integral values of gray-scale values of a plurality of scan lines are used to suppress a gray-scale value deviation with more accuracy, it means a correction circuit is required as many as the number of the scan lines in use. Such a problem arises not only in image display apparatuses using liquid crystal panels but also in image display apparatuses using light modulation devices that may cause crosstalk in a broad sense. The crosstalk in a broad sense (referred also simply to as crosstalk in this specification) here broadly means a gray-scale deviation resulted from drive control of a light modulation device.

### SUMMARY

An advantage of some aspects of the invention is to provide a technology of suppressing any gray-scale deviation caused by drive control of an image display device.

A first aspect of the invention is directed to a device control apparatus that controls an image display device including a plurality of main scan lines. The device control apparatus includes: a cumulative correction value calculation section that calculates, in response to an input image signal, a cumulative correction value in accordance with a cumulative value of each gray-scale value of input image data provided for each of the main scan lines; a cumulative correction value storage section that stores the calculated cumulative correction value for each of the main scan lines; and a device control section that controls, based on each of the cumulative correction values of N (where N is an integer of 2 or larger) of the main scan lines read from the cumulative correction value storage section, the image display device to suppress a gray-scale deviation resulted from display of the N of the main scan lines.

With the device control apparatus of the first aspect, the cumulative correction value storage section stores the cumulative correction value of input image data on a main scan line basis, and the cumulative correction values of N main scan lines read therefrom are used as a basis to control the image display device so as to suppress any gray-scale deviation resulted from control applied over the N main scan lines. This thus eliminates the need to provide a correction circuit to every cumulative correction value. As a result, no matter how many main scan lines are used for suppressing crosstalk during control application of the image display device, a single circuit can perform correction so that the correction circuit can be simplified in configuration. The resulting correction circuit can be accordingly reduced in drive power and increased in reliability.

Alternatively, in the device control apparatus of the first aspect, the device control section may suppress the gray-scale deviation by correcting the input image data based on the N of the cumulative correction values, or may include a precharge voltage generation section that generates a precharge voltage for use to control the image display device, and suppress the gray-scale deviation by adjusting the precharge voltage based on the N of the cumulative correction values, or may include a drive voltage generation section that generates a drive voltage for use to drive the image display device, and suppress the gray-scale deviation by applying a bias voltage to the drive voltage based on the N of the cumulative correction values.

In the device control device of the first aspect, the device control section may suppress the gray-scale deviation by performing a preset combination of two or more of correction and adjustment of the input image data based on at least one of the N cumulative correction values, the precharge voltage based on at least one of the N cumulative correction values for controlling the image display device, and the drive voltage based on at least one of the N cumulative correction values for controlling the image display device.

With such a configuration, in accordance with the characteristics of the image display device, the detailed control can be implemented by a combination of varying control details, e.g., correction of input image data, and adjustment of precharge voltage and drive voltage, and a plurality of cumulative correction values.

In the device control apparatus of the first aspect, the device control section may suppress the gray-scale deviation by making, for a setting, a correction or adjustment of at least one of the input image data based on at least one of the N cumulative correction values, the precharge voltage based on at least one of the N cumulative correction values for controlling the image display device, and the drive voltage based on at least one of the N cumulative correction values for controlling the image display device. If this is the configuration, a setting can be flexibly made in accordance with the characteristics of the image display device and the characteristics of the drive circuit of the image display device, for example.

In the device control apparatus of the first aspect, the device control section may drive the image display device after dividing a display screen thereof into a plurality of areas of different polarity, and every time the image display device is driven on the basis of the scan line, control the image display device to make the areas to shift in a direction vertical to a direction of the scan lines. Note here that, in the area driving mode, the main scan lines to be refereed to are increased in number as the number of the areas is increased, thereby leading to the remarkable effects.

Note here that the invention is surely not restrictive to such a device control apparatus, and can be implemented in various forms, e.g., image display apparatus using a device control device, image display method, image display control method, program (or program product) for control over image display, and projector. Herein, image display includes both self-emitting display such as PDP (Plasma Display Panel), and projection display.

### BRIEF DESCRIPTION OF THE DRAWINGS

The invention will be described with reference to the accompanying drawings, wherein like numbers reference like elements.

FIG. 1 is a block diagram showing the configuration of a liquid crystal projector 10 as an embodiment of the invention.

FIG. 2 is an illustrative diagram showing the internal configuration of a liquid crystal panel 120R in the embodiment of the invention.

FIG. 3 is an illustrative diagram showing the internal configuration of an (m,n)-th cell 302 in a cell array 310.

FIG. 4 is an illustrative diagram showing the liquid crystal panel 120R in the state of alternating current (AC) driving by a liquid crystal drive section 230 in the embodiment of the invention.

FIG. 5 is an illustrative diagram showing a display screen at a specific moment in an area driving mode in the embodiment of the invention.

FIG. 6 is an illustrative diagram showing the state of change of the display screen while main scan lines are being driven in the area driving mode in the embodiment of the invention.

FIG. 7 is an illustrative diagram showing the internal configuration of an image processing circuit 220 in the embodiment of the invention.

FIG. 8 shows a timing diagram related to the operation of the image processing circuit 220 in the embodiment of the invention.

### DESCRIPTION OF EXEMPLARY EMBODIMENT

In the below, an embodiment of the invention is described by way of an example in the following order:

A. Basic Configuration of Liquid Crystal Projector

B. Outline of Area Scan Driving Mode

C. Internal Configuration and Operation of Image Processing Circuit 220

D. Modified Example

### A. Basic Configuration of Liquid Crystal Projector

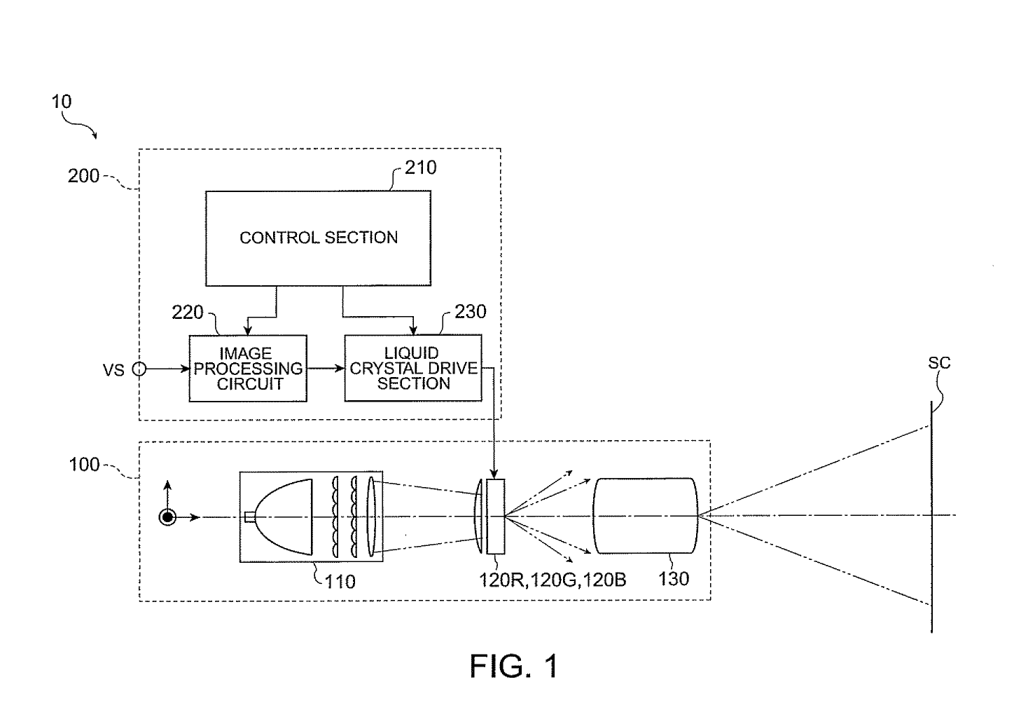

FIG. 1 is a block diagram showing the configuration of a liquid crystal projector 10 as an embodiment of the invention. The liquid crystal projector 10 is configured to include an optical system 100 and a control system 200. The optical system 100 is for image projection onto a screen SC, and the control system 200 is for controlling the optical system 100. The optical system 100 is configured to include an illumination system 110, liquid crystal panels 120R, 120G, and 120B, and a projection system 130. The control system 200 is configured to include a control section 210, an image processing circuit 220, and a liquid crystal drive section 230.

The control section 210 includes a CPU (Central Processing Unit) and a memory that are not shown. The control section 210 applies control over the image processing circuit 220 and the liquid crystal drive section 230. The image processing circuit 220 generates an input signal for transmission to the liquid crystal drive section 230 by processing an input image signal coming from the outside. Such processing of the input image signal includes various types of image processing such as image quality adjustment. The image quality adjustment includes adjustment of intensity and color temperature, for example.

The liquid crystal drive section 230 generates a drive signal for driving the liquid crystal panels 120R, 120G, and 120B based on image data coming from the image processing circuit 220. This drive signal is supplied to the liquid crystal panels 120R, 120G, and 120B, and then is used to control the amount of light passing through pixels of each of the liquid crystal panels 120R, 120G, and 120B. After passing through the liquid crystal panels 120R, 120G, and 120B, the light is directed to the projection system 130. The projection system 130 directs the light coming from each of the liquid crystal panels 120R, 120G, and 120B for projection onto the screen SC. Note here that the liquid crystal panels 120R, 120G, and 120B each correspond to an “image display device” in claims.

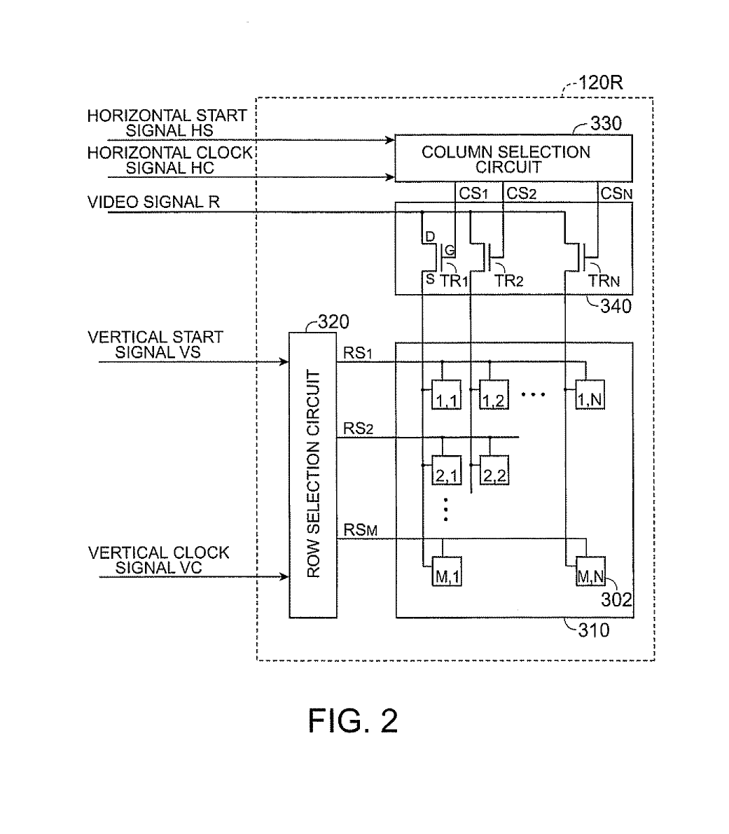

FIG. 2 is an illustrative diagram showing the internal configuration of the liquid crystal panel 120R in the embodiment of the invention. The liquid crystal panels 120G and 120B have the same internal configuration as that of the liquid crystal panel 120R. The liquid crystal panel 120R is configured to include a cell array 310, and drive circuits 320, 330, and 340 for use to drive the cell array 310. The cell array 310 includes M×N pieces of cells 302, which are arranged in a matrix of X rows and N columns. The drive circuits 320, 330, and 340 are respectively a row selection circuit, a column selection circuit, and a pixel data supply circuit.

The row selection circuit 320 includes a shift register that is not shown, and outputs row selection signals RS₁ to RS_{M} with respect to the cell array 310. This signal output is made in accordance with a vertical start signal VS and a vertical clock signal VC, both of which are provided by the liquid crystal drive section 230. This accordingly selects a plurality of cells 302 from each of the rows of the cell array 310.

The column selection circuit 330 includes a shift register that is not shown, and outputs column selection signals CS₁ to CS_{M} with respect to the pixel data supply circuit 340. This signal output is made in accordance with a horizontal start signal HS and a horizontal clock signal HC, both of which are provided by the liquid crystal drive section 230. As a result, any of the cells 302 selected from the row having been selected by the row selection circuit 320 is provided with pixel data found in color data R. Such a supply of pixel data is implemented by the row selection signals CS₁ to CS_{N} respectively turning on field-effect transistors TR₁ to TR_{N} of the pixel data supply circuit 340. Note that, in the below, the cell 302 located at the m-th row and n-th column is referred to as “(m,n)-th cell 302”.

In such a manner, the row selection circuit 320 and the column selection circuit 330 can make a sequential supply of pixel data found in the color data R to the (m,n)-th cell 302 in accordance with a signal provided by the liquid crystal drive section 230.

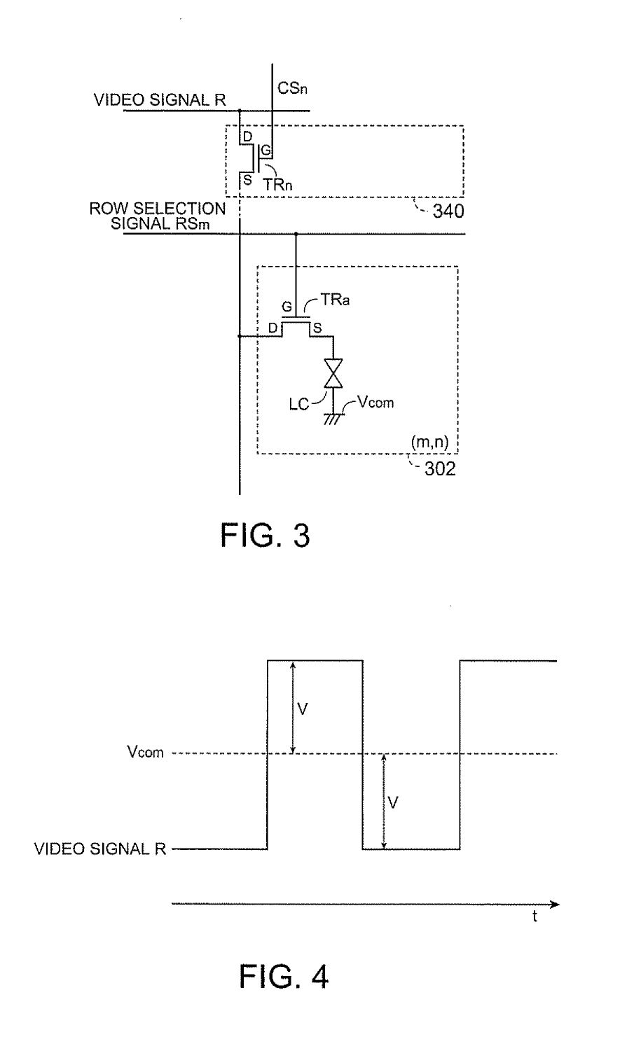

FIG. 3 is an illustrative diagram showing the internal configuration of the (m,n)-th cell 302 in the cell array 310. The (m,n)-th cell 302 is configured to include a liquid crystal element LC and an n-channel field-effect transistor TRa. These elements in the cell 302 are connected as below. That is, as to the transistor TRa, a source terminal S, a drain terminal D, and a gate terminal G are respectively connected to the liquid crystal element LC, a transistor TRn of the pixel data supply circuit 340, and the row selection circuit 320. Note that, in this embodiment, a light modulation element of a transmission type is used, but alternatively, a light modulation element of a reflection type may be used.

The terminal on the remaining end of the liquid crystal element LC is internally grounded to a shared-use opposed electrode Tcom with a potential of Vcom. This accordingly enables every liquid crystal element LC of the liquid crystal panel 120R to be driven with the potential Vcom of the shared-use opposed electrode as a reference potential.

FIG. 4 is an illustrative diagram showing the liquid crystal panel 120R in the state of alternating current (AC) driving by the liquid crystal drive section 230 in the embodiment of the invention. FIG. 4 shows the application state of a video signal R with the potential Vcom of the shared-use opposite electrode as a reference potential. The video signal R has an alternating-current waveform of a predetermined cycle. As is known from FIG. 4, the video signal R is so configured as to apply a ripple voltage with no direct-current component with respect to the potential Vcom of the shared-use opposite electrode, i.e., configured as to have any same potential difference V with respect to the potential Vcom of the shared-use opposite electrode.

Such AC driving is for preventing burn-in of the liquid crystal panels 120R, 120G, and 120B. The burn-in of the liquid crystal panels is a phenomenon of polarization caused by impurity ion in the liquid crystal material as a result of long-time application of a direct-current voltage to the liquid crystal material. Such polarization resultantly varies the resistance ratio of the liquid crystal material, thereby leaving the trace of image on the display. The previously-known AC driving includes a surface inversion driving mode and a line inversion driving mode. The surface inversion driving mode is of inverting a drive voltage at a regular cycle in the state that every pixel electrode configuring the area for image display shares the same polarity of the drive voltage, and the line inversion driving mode is of alternately inverting the polarity of any adjacent main scan lines.

However, the surface inversion driving mode has a problem of causing image quality degradation due to the influence of the binding capacity and the leakage of electric charge. On the other hand, with the line inversion driving mode, an electric field, i.e., lateral electric field, is generated between any adjacent pixel electrodes on the same substrate in the column or row direction of application of a voltage varying in polarity, thereby causing a problem of image quality degradation and reduction of aperture ratio. In consideration of such problems, the area scan driving mode has been proposed in commonly owned patent applications (JP-A-2005-227474 and JP-A-2005-258419).

### B. Outline of Area Scan Driving Mode

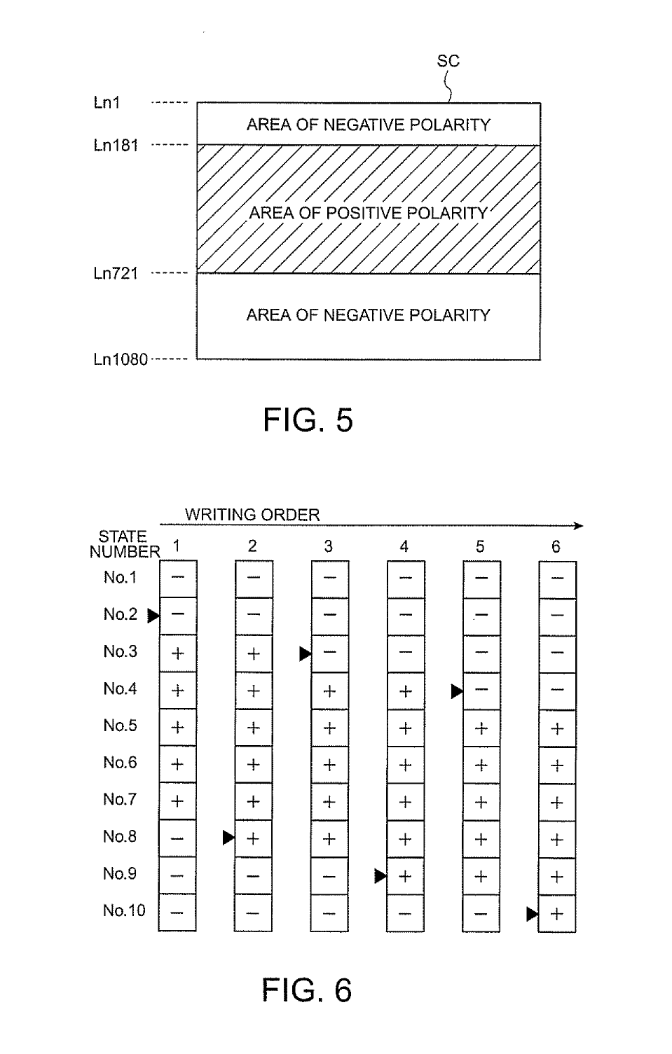

FIG. 5 is an illustrative diagram showing a display screen at a specific moment in the area driving mode in the embodiment of the invention. At the specific moment, main scan lines Ln1 to Ln180 and main scan lines Ln721 to Ln1080 are being driven by a cathode, and main scan lines Ln181 to Ln720 are being driven by an anode. These areas are shifted downward in FIG. 5 on a main scan line basis every time the main scan lines are driven.

FIG. 6 is an illustrative diagram showing the state of change of a display screen while main scan lines are being driven in the area driving mode in the embodiment of the invention. For the sake of clarity, FIG. 6 shows ten main scan lines of No. 1 to No. 10, and shows the state of change of a display, i.e., polarity, from the left toward state numbers 1 to 6.

To be specific, in the state of 1, pixels of the main scan line No. 2 are each provided with a video signal R of “negative” polarity. In the state of 2, pixels of the main scan line No. 8 are each provided with a video signal R of “positive” polarity. At this time, it is known that the polarity is changed from “negative” to “positive”. In the state of 3, pixels of the main scan line No. 3 are each provided with a video signal R. At this time, it is known that the polarity is changed from “positive” to “negative”. In the state of 4, pixels of the main scan line No. 9 are each provided with a video signal R with the polarity inversion into “positive”. In the state of 5, pixels of the main scan line No. 4 are each provided with a video signal R with the polarity inversion into “negative”. In the state of 6, pixels of the main scan line No. 10 are each provided with a video signal R with the polarity inversion into “positive”.

As such, in the area driving mode, the liquid crystal panels 120R, 120G, and 120B are each driven after a display screen thereof being divided into a plurality of areas of different polarity, and the areas are so controlled as to shift in a vertical scanning direction. This accordingly enables to suppress any image quality degradation possibly caused by factors such as the influence of the binding capacity and the leakage of electric charge by the surface inversion driving mode, and the lateral electric field by the line inversion driving mode, for example (JP-A-2005-227474 and JP-A-2005-258419).

Moreover, the analysis and experiment by the inventors revealed that, for driving of the main scan line No. 3 (the state of 3) in the area driving mode, using a cumulative value of three main scan lines of No. 2, No. 3, and No. 8 can effectively suppress any possible image quality degradation, i.e., crosstalk.

The reasons therefor are as below according to the analysis of the inventors. The first reason is that when the three main scan lines of No. 2, No. 8, and NO. 3 are driven in such an order as shown in FIG. 6, during driving of the main scan line No. 8, a correction is applied based on a cumulative correction value of the main scan line No. 2. As such, the correction affects the display of the main scan line No. 3 as is reflected therein. The second reason is that display of the main scan line No. 3 is affected not only by the driving of the main scan line No. 8 immediately driven therebefore but also by any current leakage and electric field from the main scan line No. 2 disposed next thereto in the liquid crystal panel 120R.

When some characteristics of the liquid crystal panel 120R make the first reason apparently influential, it is considered effective if a correction is applied using cumulative correction values of a plurality of main scan lines to be sequentially driven. On the other hand, when the second reason is apparently influential, it is considered effective if a correction is applied using cumulative correction values of a plurality of main scan lines to be sequentially driven, and a cumulative value of any adjacent main scan lines. In either case, the number of main scan lines to be referred to is increased so that the invention can lead to remarkable effects. The inventors have also created a circuit for achieving an efficient correction process using a cumulative value of such a plurality of main scan lines.

### C. Internal Configuration and Operation of Image Processing Circuit 220

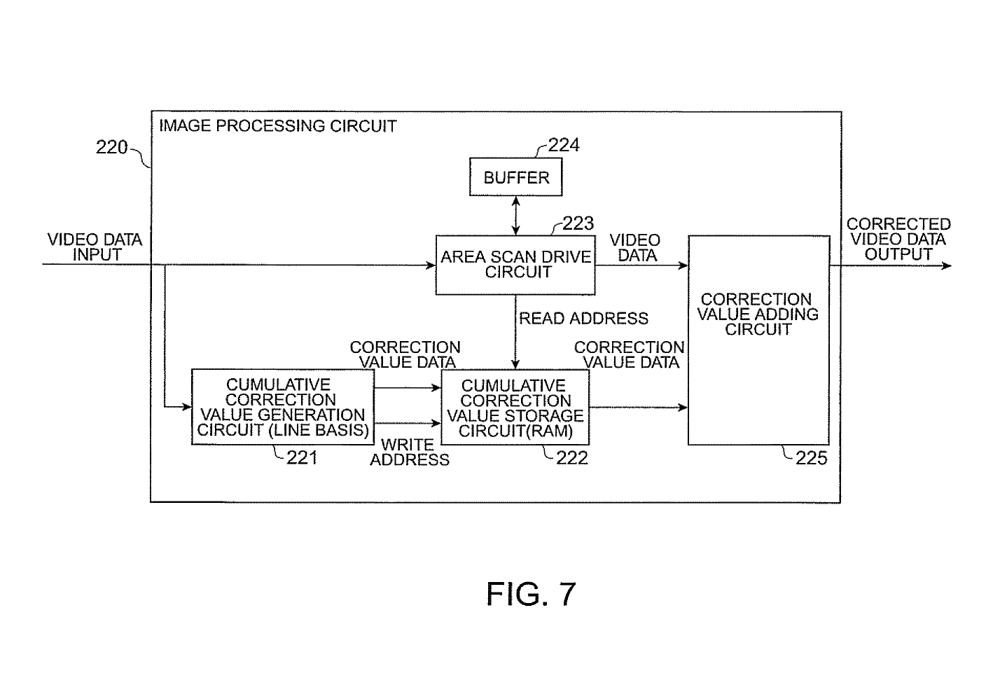

FIG. 7 is an illustrative diagram showing the internal configuration of the image processing circuit 220 in the embodiment of the invention. The image processing circuit 220 is configured to include a cumulative correction value generation circuit 221, a cumulative correction value storage circuit 222, an area scan drive circuit 223, a buffer 224, and a correction value adding circuit 225.

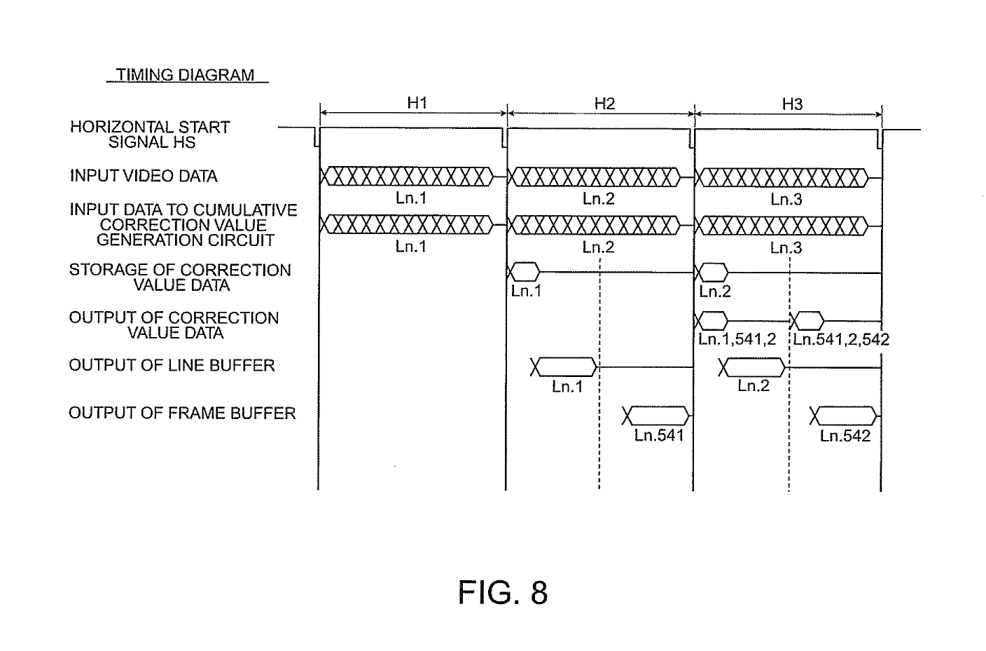

FIG. 8 shows a timing diagram related to the operation of the image processing circuit 220 in the embodiment of the invention. In this timing diagram, a horizontal start signal HS serves to define a horizontal scanning period by a rising edge. Input video data denotes a video signal for input to the image processing circuit 220. As to the input video data, “Ln.1”, “Ln.2”, and “Ln.3” each denote the number of a main scan line, and correspond to the series of main scan lines of FIG. 6.

When the image processing circuit 220 receives input video data of a main scan line under the number of “Ln.1” in the first horizontal scanning period H1, for example, a video signal R is forwarded all at once to the area scan drive circuit 223 and the cumulative correction value generation circuit 221. The area scan drive circuit 223 stores thus received input video data into the buffer 224. On the other hand, the cumulative correction value generation circuit 221 accumulates the gray-scale vale of the received input video data. The cumulative correction value calculated as such may be derived by simply accumulating the gray-scale value, or derived by accumulating a difference from a predetermined reference value, and multiplying a predetermined coefficient to the cumulative result. Such a cumulative correction value is so configured as to enable a correction through addition to the video data in this embodiment. Note here that, for the sake of clarity, in the horizontal scanning period H1, input and output of the correction value data are not shown.

In the next horizontal scanning period H2, the cumulative correction value generation circuit 221 forwards the correction value data and a write address to the cumulative correction value storage circuit 222. The write address is of specifying the number “Ln.1” of the main scan line. At the timing indicated by “storage of correction value data”, the cumulative correction value storage circuit 222 makes storage of the correction value with a correlation with the main scan line based on the write address. Note here that for the sake of clarity, output of the correction value data is not shown in the horizontal scanning period H2.

Thereafter, in the first half of the next horizontal scanning period H3, the area scan drive circuit 223 forwards a read address to the cumulative correction value storage circuit 222. The read address includes data for specifying every main scan line for use to correct the main scan line under the number of “Ln.2”. Specifically, the read address includes data for specifying the number “Ln.2” of the main scan line, the number “Ln.541” selected immediately before the main scan line, and the number “Ln.1” selected immediately before the main scan line in the same area (FIG. 6).

At the timing indicated by “output of correction value data”, the cumulative correction value storage circuit 222 forwards the correction values of the main scan lines under the numbers of “Ln.2”, “Ln.1”, and “Ln.541” to the correction value adding circuit 225. Moreover, at the timing indicated by “output of line buffer”, the area scan drive circuit 223 forwards, from a line buffer (not shown) of the buffer 224, the video data of the main scan line under the number of “Ln.2” to the correction value adding circuit 225. Herein, the correction value of the main scan line under the number of “Ln.541” is the one calculated at the same time as buffer input of the main scan line under the number of “Ln.541” before a half of the frame that is not shown.

With respect to the video data provided by the area scan drive circuit 223, the correction value adding circuit 225 applies a correction by adding three correction values received from the cumulative correction value storage circuit 222. As such, the correction video data of the main scan line under the number of “Ln.2” is output from the image processing circuit 220.

The area scan drive circuit 223 includes data for specifying every main scan line for use to correct the main scan line under the number of “Ln.542” in the latter half of the horizontal scanning period H3. Specifically, the area scan drive circuit 223 includes data for specifying the number “Ln.542” of the main scan line, the number “Ln.2” selected immediately before the main scan line, and the number “Ln.541” selected immediately before the main scan line in the same area (FIG. 6).

At the timing indicated by “output of correction value data”, the cumulative correction value storage circuit 222 forwards the correction values of the main scan lines under the numbers of “Ln.542”, “Ln.2”, and “Ln.541” to the correction value adding circuit 225. Moreover, at the timing indicated by “output of frame buffer”, the area scan drive circuit 223 forwards, from a frame buffer (not shown) of the buffer 224, the video data of the main scan line under the number of “Ln.542” to the correction value adding circuit 225.

With respect to the video data provided by the area scan drive circuit 223, the correction value adding circuit 225 applies a correction by adding together the correction data received from the cumulative correction value storage circuit 222. As such, the correction video data of the main scan line under the number of “Ln.542” is output from the image processing circuit 220. Note here that the main scan line under the number of “Ln.2” is opposite in polarity to the main scan line under the number of “Ln.542”.

As such, by performing the writing twice in each of the horizontal scanning periods, the image processing circuit 220 of the embodiment implements driving in the area driving mode. Note here that the frequency of writing may be once or three times or more.

In the embodiment, the cumulative correction value storage circuit 222 stores therein the correction values of the main scan lines as such, only one correction value adding circuit can collectively execute a correction process. This thus enables to simplify the circuit in configuration so that the drive power of the circuit can be reduced, and the reliability thereof can be increased.

### D. Modified Example

While the invention has been described in detail, the foregoing description is in all aspects illustrative and not restrictive. It is understood that numerous other modifications and variations can be devised without departing from the scope of the invention.

D-1. In the above embodiment, the area driving mode is adopted as a liquid crystal driving mode, but any other driving modes are surely applicable. In the area driving mode, the number of main scan lines to be referred to is increased as the number of the areas is increased, thereby leading to remarkable effects.

D-2. In the embodiment described above, a frame buffer and a line buffer are used, but these buffers are not essential. When a buffer is used, for example, the storage area of the buffer may be partially used for storage of cumulative correction values. This is because the data size of the cumulative values is negligibly small compared with the size of the data representing the gray-scale value of each of the main scan lines.

D-3. In the above embodiment, the image data is so configured as to be corrected in accordance with a plurality of cumulative correction values. Alternatively, as described in JP-A-2005-202159, the cumulative correction value may be used as a basis for adjustment of a precharge voltage, or as a basis for application of a bias voltage to a drive voltage. The device control section of the embodiment of the invention may generally serve well as long as it is configured to control the image display device in such a manner as to suppress, based on the cumulative correction value of each of N main scan lines, any gray-scale deviation resulted from control applied over the N main scan lines.

D-4. In the above embodiment, exemplified is the case of using the liquid crystal panel 120R of a transmission type. This is surely not restrictive, and a liquid crystal panel of a reflection type will also do. The light modulation device of a reflection type includes a liquid crystal panel of a reflection type, a display device of non-light-emitting type such as digital micromirror device (DMD; trademark of Texas Instruments, USA), a projector using a display device with various types of electrooptic element such as light-emitting display device including PDP, EL (ElectroLuminescent), LED (Light-Emitting Diode), and others, and any other image display apparatuses.

What is claimed is:

1. A device control apparatus that controls an image display device including a plurality of main scan lines, the apparatus comprising:
a cumulative correction value calculation section that calculates, in response to an input image signal, a cumulative correction value in accordance with a cumulative value of each gray-scale value of input image data provided for each of the main scan lines;
a cumulative correction value storage section that stores the calculated cumulative correction value for each of the main scan lines; and
a device control section that controls, based on N (where N is an integer of 2 or larger) of the main scan lines read from the cumulative correction value storage section, the image display device to suppress a gray-scale deviation resulted from display of the N of the main scan lines.

2. The device control apparatus according to claim 1, wherein
the device control section suppresses the gray-scale deviation by correcting the input image data based on the N of the cumulative correction values.

3. The device control apparatus according to claim 1, wherein
the device control section includes a precharge voltage generation section that generates a precharge voltage for use to control the image display device, and suppresses the gray-scale deviation by adjusting the precharge voltage based on the N of the cumulative correction values.

4. The device control apparatus according to claim 1, wherein
the device control section includes a drive voltage generation section that generates a drive voltage for use to drive the image display device, and suppresses the gray-scale deviation by applying a bias voltage to the drive voltage based on the N of the cumulative correction values.

5. A device control apparatus according to claim 1, wherein
the device control section suppresses the gray-scale deviation by performing a preset combination of two or more of correction and adjustment of the input image data based on at least one of the N cumulative correction values, the precharge voltage based on at least one of the N cumulative correction values for controlling the image display device, and the drive voltage based on at least one of the N cumulative correction values for controlling the image display device.

6. The device control device according to claim 1, wherein
the device control section suppresses the gray-scale deviation by making, for a setting, a correction or adjustment of at least one of the input image data based on at least one of the N cumulative correction values, the precharge voltage based on at least one of the N cumulative correction values for controlling the image display device, and the drive voltage based on at least one of the N cumulative correction values for controlling the image display device.

7. The device control apparatus according to claim 1, wherein
the device control section drives the image display device after dividing a display screen thereof into a plurality of areas of different polarity, and every time the image display device is driven on the basis of the scan line, controls the image display device to make the areas to shift in a direction vertical to a direction of the scan lines.

8. An image display apparatus, comprising:
an image display device including a plurality of main scan lines; and
the device control apparatus of claim 1 that controls the image display device.

9. A projector, comprising:
a light source;
an image display device that modulates, in accordance with an input image signal, a light coming from the light source; and
the device control apparatus of claim 1 that controls the image display device.

10. A device control method of controlling an image display device including a plurality of main scan lines, the method comprising:
calculating, in response to an input image signal, a cumulative correction value in accordance with a cumulative value of each gray-scale value of input image data provided for each of the main scan lines;
storing the calculated cumulative correction value for each of the main scan lines; and
controlling, based on N (where N is an integer of 2 or larger) of the main scan lines read from a cumulative correction value storage section, the image display device to suppress a gray-scale deviation resulted from display of the N of the main scan lines.
